(19) United States
(12) Patent Application Publication
(10) Pub. No.: US 2025/0170891 A1
(43) Pub. Date: May 29, 2025

(54) INFORMATION PROCESSING DEVICE AND NON-TRANSITORY, COMPUTER-READABLE RECORDING MEDIUM THEREFOR

(71) Applicant: Faurecia Clarion Electronics Co., Ltd., Saitama-shi (JP)

(72) Inventors: Takuma SHIOGUCHI, Saitama (JP); Keiichiro YOSHIHARA, Saitama (JP); Kenta YASUTOMO, Saitama (JP); Jun KAWANO, Saitama (JP); Takahiro UEMURA, Saitama (JP)

(21) Appl. No.: 18/944,231

(22) Filed: Nov. 12, 2024

(30) Foreign Application Priority Data
Nov. 24, 2023 (JP) 2023-199373

(51) Int. Cl. B60K 35/22; B60K 35/10; G06F 3/0488

(52) U.S. Cl. CPC B60K 35/22; B60K 35/10; G06F 3/0488; B60K 2360/1438

(57) ABSTRACT

An information processing device including: a detection unit that detects a touch operation on a screen; an operation area display control unit that displays a first operation area when a first touch operation of sliding a touch position on the screen is detected; and an object display control unit that, when a second touch operation in the first operation area is detected, moves an object to be displayed and that is subject to display control by sliding a predetermined distance toward a starting point side of the touch position of the first touch operation. The operation area display control unit displays the first operation area at a position between the starting point and one side of the screen intersecting with a straight line extending in a sliding direction of the first touch operation from the starting point, the position being away from the one side of the screen.

### TECHNICAL FIELD

The present disclosure relates to an information processing device and to a computer program.

### BACKGROUND

Display devices having large screens have come into practical use. For example, Patent Document 1 describes an information processing device that performs display control of this type of display device.

The information processing device described in Patent Document 1 changes the display range of an image in a screen region that displays the same image as that displayed in an electronic side mirror in response to a touch operation on the screen of a display device installed inside a vehicle cabin.
Patent Document 1: Japanese Unexamined Patent Application 2022-11370.

In Patent Document 1, a screen of the display device is sized to cover almost the entire dashboard. In such a case, it may be difficult for a driver sitting in a driver seat to touch operate a region within an object displayed closer to a front passenger seat on a screen, for example because a finger cannot reach the screen. Thus, there is room for improvement in Patent Document 1 from the perspective of improving the operability of a touch operation in a region within an object away from an operator.

### SUMMARY

In view of the foregoing, an aspect of the present disclosure aims to provide an information processing device and a computer program that can improve the operability of a touch operation in a region within an object away from the operator.

An information processing device according to an embodiment of the present disclosure includes: a detection unit that detects a touch operation on a screen; an operation area display control unit that displays a first operation area on the screen when a first touch operation of sliding a touch position on the screen is detected by the detection unit; and an object display control unit that, when a second touch operation in the first operation area is detected by the detection unit, moves an object to be displayed on the screen and that is subject to display control by sliding a predetermined distance toward a starting point side of the touch position of the first touch operation. The operation area display control unit displays the first operation area at a position between the starting point and one side of the screen intersecting with a straight line extending in a sliding direction of the first touch operation from the starting point, the position being away from the one side of the screen.

An embodiment of the present disclosure provides an information processing device and a computer program, which can improve the operability of a touch operation in a region within an object away from an operator.

### BRIEF DESCRIPTION OF THE DRAWINGS

FIG. 1 is a diagram schematically illustrating a vehicle in which an in-vehicle system is installed according to an embodiment of the present disclosure;

FIG. 2 is a block diagram illustrating a hardware configuration of an in-vehicle system according to an embodiment of the present disclosure;

FIG. 3 is a diagram illustrating an example of a display screen displayed on a screen of a display unit in an embodiment of the present disclosure;

FIG. 4 is a diagram illustrating an example of a display screen when an operation area is displayed on a screen of a display unit in an embodiment of the present disclosure;

FIG. 5 is a diagram illustrating an example of a display screen when a map image displayed on a screen of a display unit is moved by sliding in an embodiment of the present disclosure;

FIG. 6 is a diagram illustrating an example of a display screen when a map image displayed on a screen of a display unit is moved by sliding in an embodiment of the present disclosure;

FIG. 7 is a diagram illustrating an example of a display screen when the scale of a map image displayed on a screen of a display unit is enlarged in an embodiment of the present disclosure;

FIG. 8 is a diagram illustrating an example of a display screen when the scale of a map image displayed on a screen of a display unit is enlarged in an embodiment of the present disclosure;

FIG. 9 is a diagram illustrating an example of a display screen displayed on a screen of a display unit in an embodiment of the present disclosure;

FIG. 10 is a diagram illustrating an example of a display screen displayed on a screen of a display unit in an embodiment of the present disclosure;

FIG. 11 is a flowchart illustrating a process executed by a control unit included in the in-vehicle system according to an embodiment of the present disclosure; and

FIG. 12 is a diagram illustrating an example of a display screen when the scale of a map image displayed on a screen of a display unit is enlarged in a modified example of the present disclosure.

### DETAILED DESCRIPTION OF EMBODIMENTS

The following description relates to an information processing device and a computer program stored on a non-transitory, computer-readable recording medium according to an embodiment of the present disclosure. Note that common or corresponding elements are marked with the same or similar reference codes, and duplicate descriptions are simplified or omitted as appropriate.

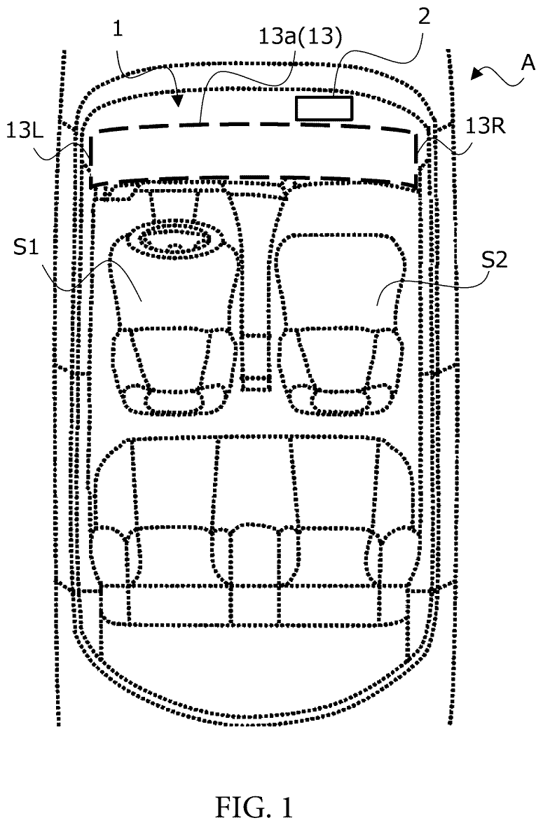

FIG. 1 is a diagram schematically illustrating a vehicle A in which is installed an in-vehicle system 1 according to an embodiment of the present disclosure. The vehicle A is an example of a moving body, and is a left-hand drive vehicle. The vehicle A may be a right-hand drive vehicle.

The in-vehicle system 1 includes, for example, a main unit 2 installed in a dashboard and a display unit 13 connected to the main unit 2. The screen 13a of the display unit 13 is sized to extend from close to the right front pillar to close to the left front pillar. The reference code 13R designates the right end of the screen 13a positioned close to the right front pillar. The reference code 13L designates the left end of the screen 13a positioned close to the left front pillar. The upper end of the screen 13a is marked with the reference code 13U. The lower end of the screen 13a is marked with the reference code 13D.

In this manner, the display unit 13, which is an example of a display device, is installed inside the vehicle A. A seat row is installed inside vehicle A, including a driver seat S1 and a front passenger seat S2 (an example of a left seat and a right seat aligned in the same row, and an example of a first seat and a second seat aligned in a first direction). The screen 13a of the display unit 13 is positioned in front of the seat row and is formed to extend in the vehicle width direction of the vehicle A.

Note that any reference to an element using a designation such as “first”, “second”, or the like as used in the present disclosure does not generally limit the quantity or order of those elements. These designations are used for convenience to distinguish between two or more elements. Thus, a reference to first and second elements does not mean, for example, that only two elements are employed or that the first element must precede the second element.

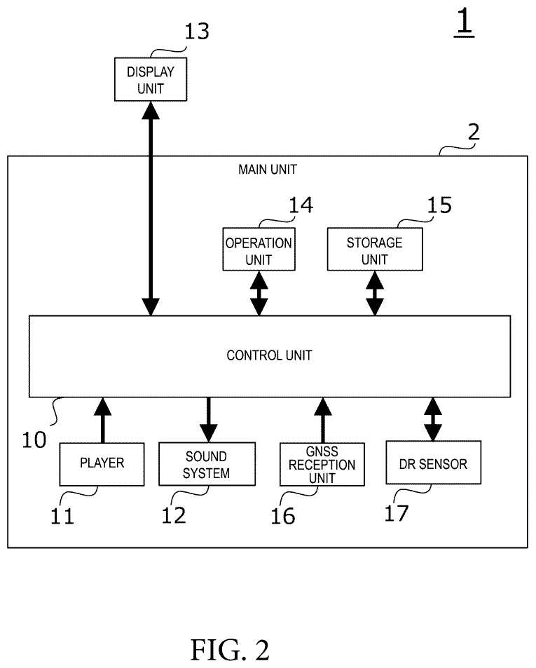

FIG. 2 is a block diagram illustrating a hardware configuration of an in-vehicle system 1 according to an embodiment of the present disclosure. The in-vehicle system 1 includes a main unit 2 (an example of an information processing device) connected to a touch-operable display device (display unit 13 in the present embodiment). The in-vehicle system 1 is equipped with various functions including, for example, an audio function and a navigation function. The in-vehicle system 1 may be a device that is a portion of an IVI (In-Vehicle Infotainment) system.

As illustrated in FIG. 2, the main unit 2 includes a control unit 10, a player 11, a sound system 12, an operation unit 14, a storage unit 15, a Global Navigation Satellite System (GNSS) reception unit 16, and a Dead Reckoning (DR) sensor 17.

The main unit 2 may be configured to include only a portion of structural elements (e.g., the control unit 10 and the storage unit 15). In this case, other structural elements (such as the player 11 and the like) that are not included in the main unit 2 may be configured as units that are independent of the main unit 2. In addition, the main unit 2 may be configured as a single vehicle-mounted device that includes a display unit 13 in addition to the control unit 10, player 11, sound system 12, operation unit 14, storage unit 15, GNSS reception unit 16, and DR sensor 17.

Furthermore, the in-vehicle system 1 may include another component not illustrated in FIG. 2. In other words, there is a degree of freedom in the configuration of the in-vehicle system 1 and the main unit 2, and various design changes are possible.

The player 11 is connected to a sound source. The player 11 plays an audio signal input from the sound source, which is then output to the control unit 10.

Examples of the sound source include disk media such as compact discs (CDs), Super Audio CDs (SACDs) and the like, storage media such as hard disk drives (HDDs), Universal Serial Buses (USBs) and the like, smartphones, tablet terminals that store digital audio data, and servers that perform streaming via a network. When the sound source is streamed or when the sound source is stored in the storage unit 15 described later, the player 11 as individual hardware may be omitted.

The main unit 2 is an example of an information processing device according to an embodiment of the present disclosure, and is an example of a computer for executing the information processing method and information processing program according to the present embodiment. In other words, the information processing device according to the present embodiment is incorporated into the in-vehicle system 1 as the main unit 2.

The control unit 10 is configured, for example, as a large scale integration (LSI), and is provided with a central processing unit (CPU), a random-access memory (RAM), a read-only memory (ROM), and a digital signal processor (DSP).

The control unit 10 executes various programs developed in a work area of the RAM. As a result, the control unit 10 controls the operation of the in-vehicle system 1.

The control unit 10 is, for example, a single processor or a multiprocessor, and includes at least one processor. When configured to include a plurality of processors, the control unit 10 may be packaged as a single device, or may be configured as a plurality of devices that are physically separated within the in-vehicle system 1.

The control unit 10 processes a digital audio signal input from the player 11 or the storage unit 15, which is then output to the sound system 12.

The sound system 12 includes a D/A converter, amplifier, and the like. The digital audio signal is converted to an analog signal by the D/A converter. This analog signal is amplified by the amplifier and output to each speaker installed in a vehicle cabin. As a result, music recorded in the sound source, for example, is played in the vehicle cabin from each speaker.

The display unit 13 is a device that displays various screens and examples include displays configured of a liquid crystal display (LCD) or organic electro luminescence (EL). The display is equipped with a touch panel.

A user (operator) can perform various touch operations on the display (screen 13a), such as touch on (touching screen 13a with a finger), touch off (removing a finger from screen 13a), flick (flicking a finger across screen 13a), swipe (slide), drag, drop, and the like.

The control unit 10 detects the coordinates on the screen 13a that are touch operated, and executes a process associated with the detected coordinates.

In other words, the display unit 13 is an example of a touch-operable display device. In addition, the control unit 10 is connected to the display unit 13 which is an example of a display device.

The operation unit 14 includes mechanical operating elements such as switches, buttons, knobs, and wheels, that are mechanical systems, capacitance non-contact systems, membrane systems, or the like. Furthermore, the display unit 13 equipped with a touch panel display forms a portion of the operation unit 14. A GUI on which touch-operable operating elements are arranged is displayed on a screen 13a of the display unit 13.

An operator can operate the in-vehicle system 1 via a mechanical operating element or an operating element on the GUI (Graphical User Interface).

The storage unit 15 is an auxiliary storage device or a flash memory such as a hard disk drive (HDD) or solid-state drive (SSD). Various programs such as an information processing program or the like for executing the information processing method according to the present embodiment and various data such as map data for navigation and the like are stored in the storage unit 15. In one example, the memory unit 15 includes a non-transitory, computer-readable recording medium having a computer program stored thereon that can be executed by an electronic processor of the information processing device. When the player 11 is omitted, sound source data is also stored in the storage unit 15.

The GNSS reception unit 16 measures the current position of the vehicle on the basis of a GNSS signal received from a plurality of GNSS satellites. The GNSS reception unit 16 measures the current position at a predetermined time interval (e.g., every second), and outputs the measurement result to the control unit 10. A representative example of GNSS is the Global Positioning System (GPS).

The control unit 10 renders the map data stored in the storage unit 15 to display the map on the screen 13a of the display unit 13, acquires the current position measured by the GNSS reception unit 16, and superimposes a mark indicating the position of one's own vehicle at the acquired current position, which is a position on a road on the map displayed on the screen 13a of the display unit 13 (map matching).

The DR sensor 17 includes various sensors such as a gyro sensor that measures an angular velocity related to a bearing in a horizontal plane of the vehicle and a vehicle speed sensor that detects a rotation speed of left and right driving wheels of the vehicle.

The control unit 10 may also estimate the current position from information acquired from the DR sensor 17. The control unit 10 may determine a final current position by comparing both the current position acquired from the GNSS reception unit 16 and the current position estimated on the basis of the information acquired from the DR sensor 17.

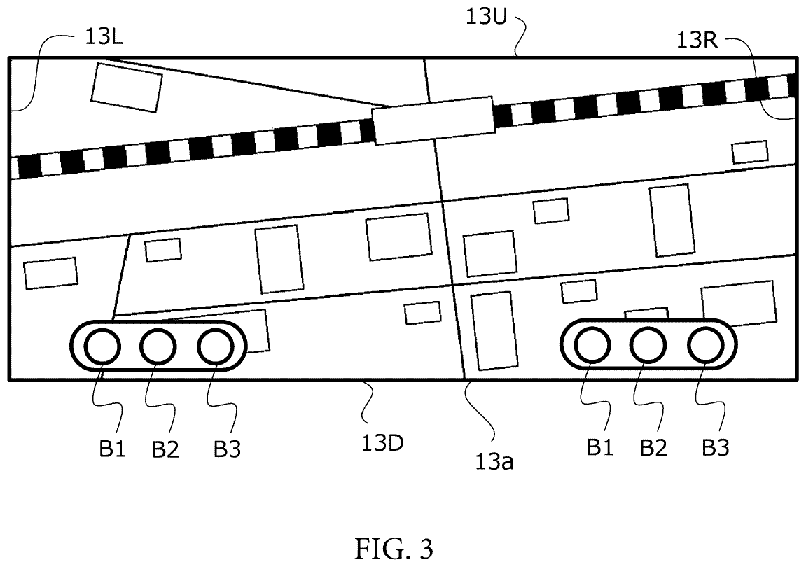

FIG. 3 illustrates an example of a display screen displayed on the screen 13a of the display unit 13. On the screen 13a, for example, a navigation map image (example of an object) is displayed.

The object is a display object for displaying, on the screen 13a, the type of application or information processed by the application, or is a display object symbolizing such information, and the shape and size thereof are variable. Examples include widgets, icons, thumbnail images, pop-ups, lists, and information display windows. A widget is a display object that includes interface components of a GUI (Graphical User Interface) and displays the results of processing by an application corresponding to that widget, and lays out a reception region for receiving instructions to be processed by that application. The object may be referred to by another name, such as content or the like.

The objects include, for example, objects that display information related to the navigation function, objects that display an overhead image of the vehicle when parking, objects for operating the audio functions installed in the in-vehicle system 1, objects for selecting radio stations, objects for adjusting the temperature and air volume of the air conditioner installed in the vehicle, and objects for displaying and setting various information related to the vehicle (e.g., speedometer, tachometer).

In the example of FIG. 3, icons B1 to B3 are displayed close to the left end 13L of the screen 13a (in other words, close to the driver seat S1). Icons B1 to B3 are also displayed close to the right end 13R of the screen 13a (in other words, close to the front passenger seat S2).

The icons B1 to B3 are operating elements associated with commands that have some effect on an object. For example, when an icon B1 for searching for a restaurant is dragged and dropped onto a map image, the coordinate position of the restaurant on the map is highlighted. When the operator touches the highlighted coordinate position, the corresponding restaurant is set as the destination.

The icons B1 to B3 close to the left end 13L are positioned close to the driver seat S1 and are difficult to reach from the front passenger seat S2. Therefore, the icons B1 to B3 close to the left end 13L can be referred to as operating elements for an operator (hereinafter referred to as “driver”) seated in the driver seat S1.

The icons B1 to B3 close to the right end 13R are positioned close to the front passenger seat S2 and are difficult to reach from the driver seat S1. Therefore, the icons B1 to B3 close to the right end 13R can be referred to as operating elements for an operator (hereinafter referred to as “passenger”) seated in the front passenger seat S2.

For convenience, the icons B1 to B3 close to the left end 13L will be referred to as “driver icons B1 to B3”. The icons B1 to B3 close to the right end 13R are designated as “passenger icons B1 to B3”. Furthermore, the driver's icons and passenger's icons are collectively referred to as “operation icons”.

The display positions of the icons B1 to B3 are not limited to those described above. For example, when a long-press operation (i.e., an operation of touching the screen 13a without moving a finger for a predetermined period of time or more) is detected, the icons B1 to B3 may be displayed at the position of the detected long-press operation.

In the example of FIG. 3, the region of the map image near the right end 13R of the screen 13a is away from the driver and difficult for a driver's finger to reach. Thus, it is not easy for the driver to touch operate such a region. The difficulty of operation further increases when the vehicle body vibrates during vehicle travel or when a delicate touch operation is required.

Therefore, it is desirable to improve the operability of touch operations in a region within an object away from the operator (e.g., a region of the map image near the right end 13R of the screen 13a).

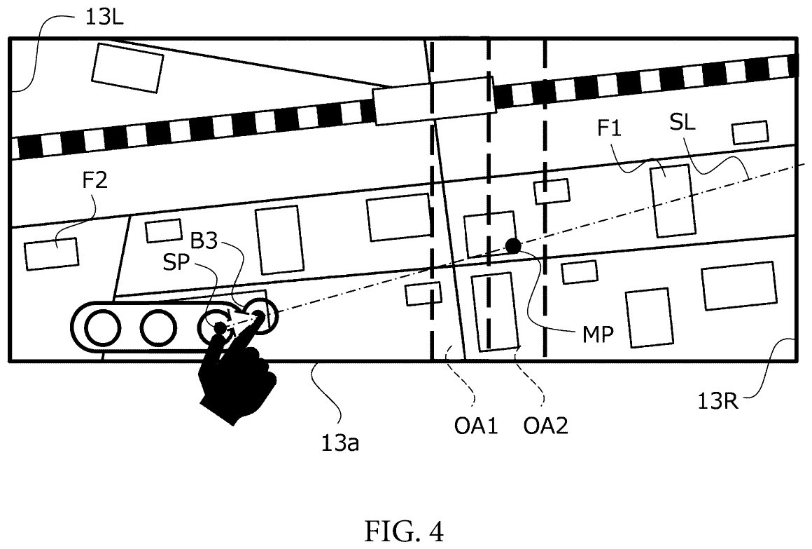

FIGS. 4 to 9 illustrates examples of the display screen when a touch operation is performed on the screen 13a. The hand illustrated in each of the drawings illustrating display screen examples including FIG. 4 indicates the manner in which the operator touches the screen 13a. Furthermore, the outline arrows illustrated by dashed lines indicate the movement of the operator's finger and the movement of the map image.

Each of FIGS. 4 to 9 illustrates a condition in which the driver icon B3 is dragged on the map image. As illustrated in FIG. 4, when dragging of the driver icon B3 starts, two operation areas OA1 and OA2 are displayed slightly to the right of the center of the screen 13a.

The operation areas OA1 and OA2 may be displayed, for example, as areas separated by dashed lines as illustrated in FIG. 4, or may be displayed in the form of semi-transparent rectangular shapes superimposed on the map image.

In the example of FIG. 4, the driver icons B1 to B3 including the drag-operated driver icon B3 continue to be displayed, while the passenger icons B1 to B3 are erased. In another embodiment, even after the drag operation, both the driver icons B1 to B3 and the passenger icons B1 to B3 may continue to be displayed.

Straight line SL indicated by a dash-dotted line is a straight line extending from a starting point SP of the operator's touch position on the screen 13a (in the example of FIG. 4, the starting point when the driver icon B3 moves by a drag operation) in the sliding direction of the touch position (in the example of FIG. 4, the dragging direction of the driver's icon B3).

The operation areas OA1 and OA2 are displayed between the starting point SP and the right end 13R of the screen 13a (example of one side of the screen) that intersects with the straight line SL, and at a position away from the right end 13R. More specifically, the operation areas OA1 and OA2 are at a position that can be easily reached by a driver's finger, and are displayed, for example, on the starting point SP side rather than a midpoint MP between the starting point SP and the right end 13R (example of one side of the screen).

Note that in the example of FIG. 4, of the operation areas OA1 and OA2, only the operation area OA1 is displayed closer to the starting point SP side than the midpoint MP. In other words, an embodiment of the present disclosure is not limited to the case where these operation areas are displayed on the starting point SP side from the midpoint MP. The operation areas OA1 and OA2 may be displayed at positions that can be easily reached by the driver's finger.

A region to the right of the operation area OA2 (to the right end 13R side) is too far away from the driver, and thus is difficult for the driver's finger to reach. In the example of FIG. 4, a facility F1 on the map image that the driver wants to touch operate is positioned in a region that is difficult for the driver's finger to reach.

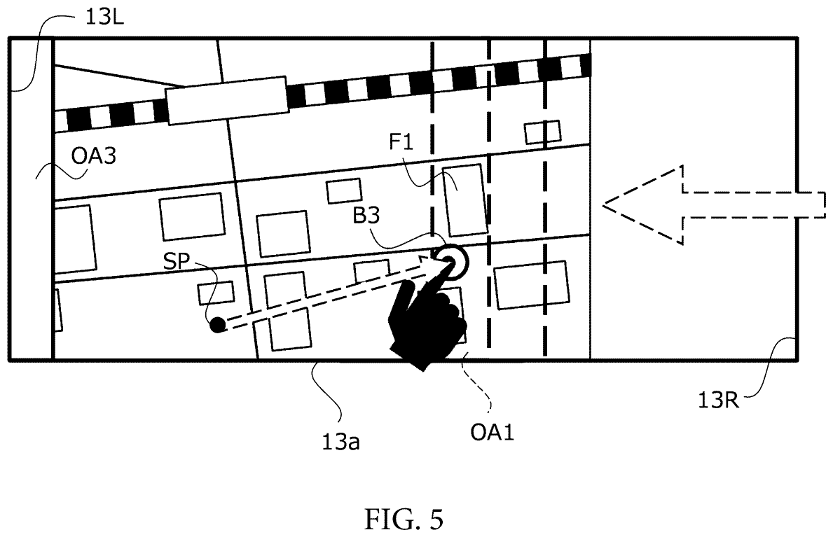

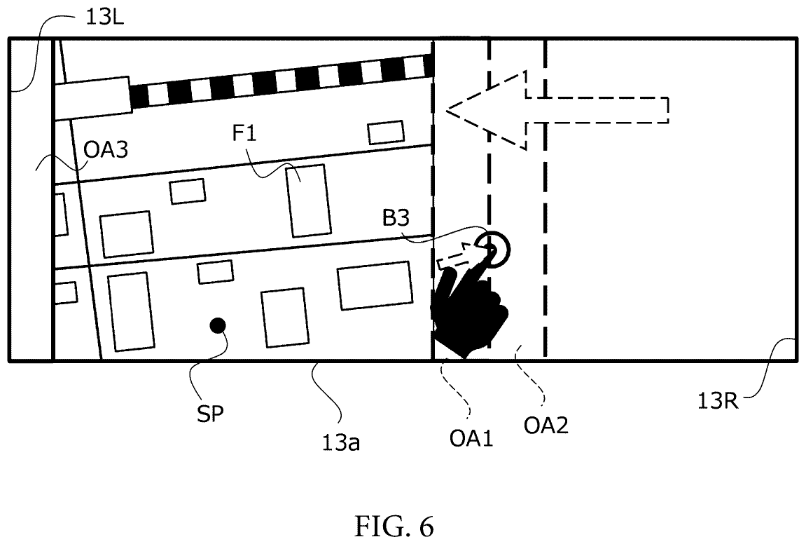

As illustrated in FIG. 5, when the driver icon B3 is dragged into the operation area OA1, the map image moves a predetermined distance by sliding toward the starting point SP side (to the left on the screen in the example of FIG. 5). As the driver icon B3 is dragged toward a back side of the operation area OA1 (in other words, the operation area OA2 side), the map image moves by sliding toward the left on the screen as illustrated in FIG. 6.

Note that even if the driver icon B3 is dragged to a front side within the operation area OA1 (in other words, side away from the operation area OA2), the map image does not slide. This prevents the map image from unintentionally sliding.

As illustrated in FIG. 6, the map image is slid up to a maximum position where the right end of the map image exceeds the operation area OA1.

As illustrated in FIGS. 5 and 6, the map image moves in a stepwise sliding manner according to the drag position. In another embodiment, the sliding movement of the map image need not be stepwise. The map image may be slid to a maximum position (see FIG. 6) at a time point when the driver icon B3 is dragged into the operation area OA1.

The map image may be slid according to the holding time (time that the finger performing the drag operation remains within the operation area OA1). In this case, the operator can adjust the sliding amount of the map image on the basis of the time for which the operator holds the finger performing the drag operation within the operation area OA1.

Thus, the driver can drag the driver icon B3 into the operation area OA1 to move the map image by sliding and bring a region of the map image that was difficult for a driver's finger to reach closer to the driver side. This enables the driver to easily perform a touch operation on the facility F1 on the map image.

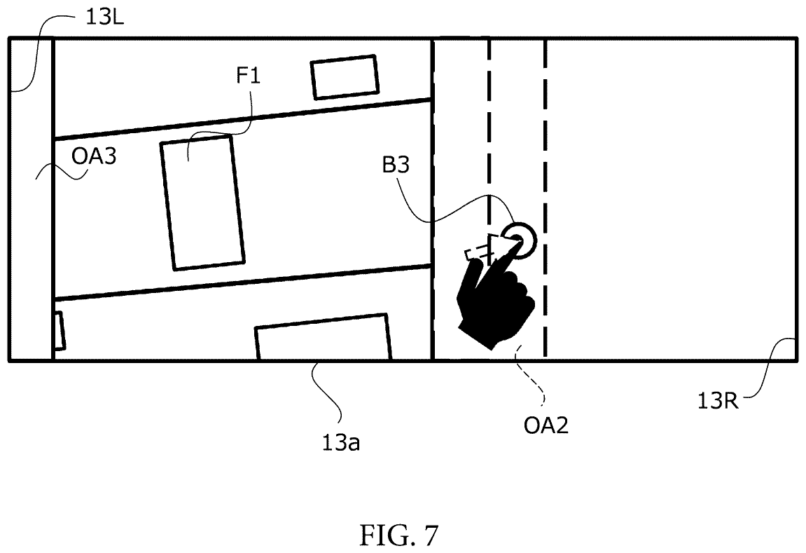

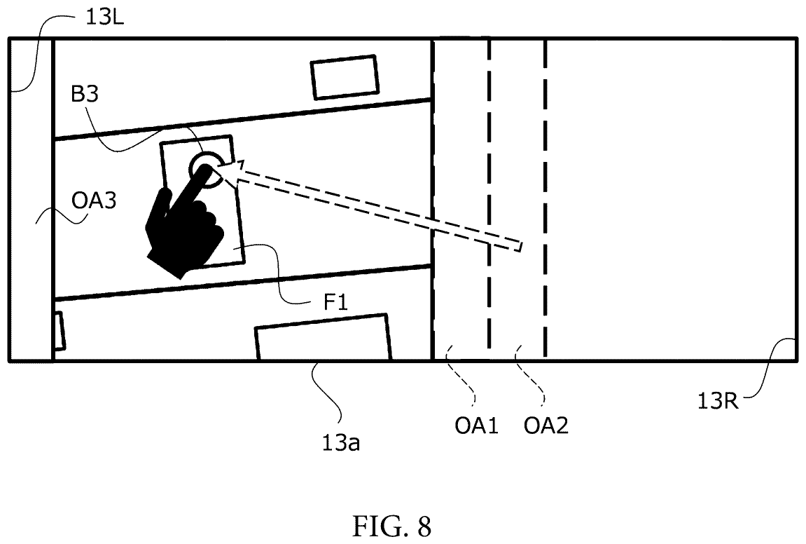

As illustrated in FIG. 7, when the driver icon B3 is dragged into the operation area OA2, the scale of the map image is enlarged. This causes the facility F1 to be displayed larger on the map image. This makes it easier for the driver to perform a touch operation on the facility F1 on the map image (see FIG. 8).

The scale of the map image can be enlarged in a stepwise or stepless manner.

For example, each time the driver icon B3 is dragged a predetermined distance toward a back side of the operation area OA2 (in other words, the right end 13R side of the screen 13a), the scale of the map image is enlarged by a predetermined factor. In other words, the scale of the map image is enlarged in a stepwise manner.

Alternatively, as the driver icon B3 is dragged to the back side of the operation area OA2, the scale of the map image enlarges. In other words, the scale of the map image is enlarged in a stepless manner. More precisely, each time a drag operation amount of a value corresponding to a minimum resolution detectable by the touch panel display is detected, the scale of the map image is enlarged by the minimum unit processable by the DSP. In other words, the scale of the map image is enlarged in small increments so as to be considered to be substantially stepless.

The operation area OA2 is displayed at a position adjacent to the operation area OA1. This allows the driver to smoothly perform a sliding movement of the map image and enlarge the scale with a series of drag operations.

In an embodiment of the present disclosure, the operation area OA2 is displayed to the immediate right of the operation area OA1, but the display position of the operation area OA2 is not limited thereto. The operation area OA2 may be displayed in another position, such as to the immediate left or the like of operation area OA1.

Note that instead of drag operation on the driver icons B1 to B3, the driver can also touch an arbitrary position on the screen 13a and slide the touching finger to the operation area OA1 or OA2, as illustrated in FIGS. 5 and 6, to move the map image by sliding, and can also enlarge the scale of the map image as illustrated in FIG. 7. In other words, when sliding the map image or enlarging the scale, the drag operation of the driver icons B1 to B3 is not essential.

As illustrated in FIG. 5, when the driver icon B3 is dragged into the operation area OA1, the operation area OA3 is displayed superimposed on the map image simultaneously with the start of the sliding of the map image.

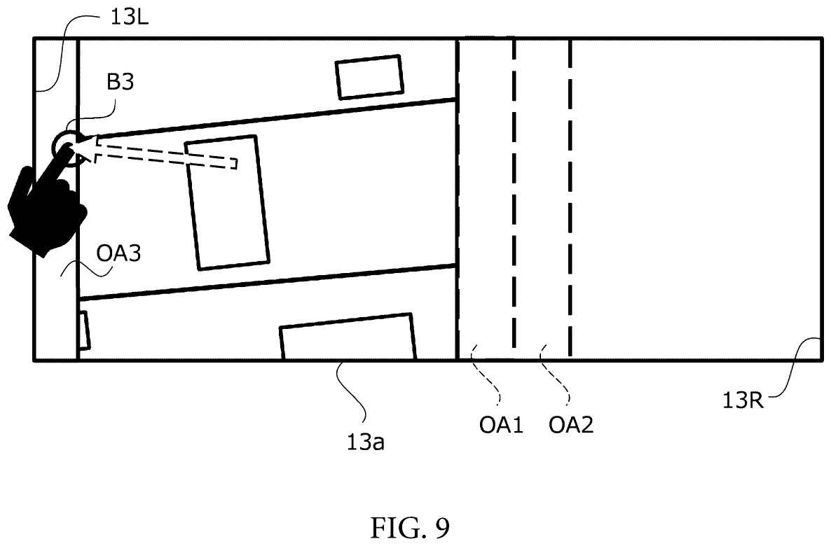

As illustrated in FIG. 9, when a touch operation is performed on the operation area OA3 (such as a drag operation into the operation area OA3, an operation of tapping the operation area OA3, and the like), the map image returns to the display form before the drag operation. In other words, the map image returns to the display position and scale before the drag operation. This allows, for example, the screen of FIG. 3 to be displayed. Thus, the operator can easily return the map image to its original display form.

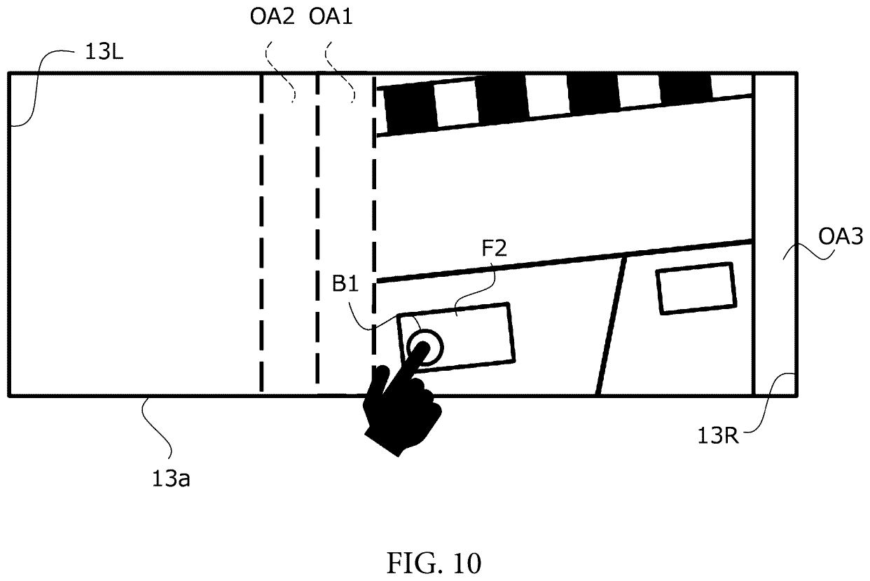

Examples of display screens when the operator is a driver have been described using FIGS. 4 to 9. FIG. 10 illustrates an example of a display screen when the operator is a passenger. Herein, a facility F2 on the map image that the passenger wants to touch operate is positioned in a region that is difficult for a passenger's finger to reach (see FIG. 4).

For example, when a passenger icon B1 is slid toward the left end 13L side of screen 13a, two operation areas OA1 and OA2 are displayed slightly to the left of the center of screen 13a (in other words, at a position that can be easily reached by a passenger's finger). When the passenger icon B1 is dragged into the operation area OA1, the map image moves to the right on the screen by sliding. Furthermore, when the passenger icon B1 is dragged into the operation area OA2, the scale of the map image is enlarged.

By dragging the passenger icon B1 into the operation area OA1, the passenger can move the map image by sliding and bring a region in the map image that is difficult for a passenger's finger to reach closer to the passenger side. This enables the passenger to easily perform a touch operation on the facility F2 on the map image.

Furthermore, the passenger can enlarge the scale of the map image by dragging the passenger icon B1 into the operation area OA2. This causes the facility F2 to be displayed larger on the map image. This makes it easier for the passenger to perform a touch operation on the facility F2 on the map image (see FIG. 10).

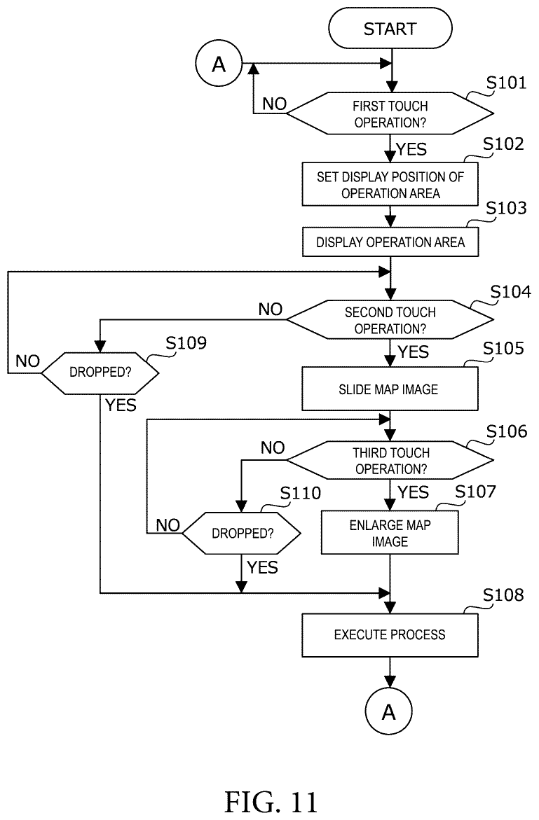

FIG. 11 is a flowchart illustrating the processing of a computer program, such as the information processing program, executed by an electronic processor of the control unit 10 in an embodiment of the present disclosure. For example, when the in-vehicle system 1 is started, the execution of the process illustrated in FIG. 11 is started. When the in-vehicle system 1 is shut down, the process illustrated in FIG. 11 terminates.

Note that the order of the steps in the flowcharts illustrated in the present embodiment may be changed as long as there is no inconsistency. Furthermore, the steps of the flowcharts illustrated in the present embodiment may be in parallel or in may be executed in parallel as long as there is no contradiction. For example, the present disclosure presents the processing of various steps using an example order, but such is not limited to the order presented.

The control unit 10 waits for a first touch operation on the screen 13a (step S101). The first touch operation is an operation of sliding the touch position on the screen 13a, for example, an operation of dragging an operation icon.

When the control unit 10 operating as a detection unit detects the first touch operation (step S101: YES), the control unit 10 sets the display positions of the operation areas OA1 and OA2 (step S102).

Specifically, the control unit 10 sets the display positions of the operation areas OA1 and OA2 to positions between the starting point SP of the operator's touch position on the screen 13a and one side of the screen 13a intersecting with the straight line SL extending from the starting point SP in the sliding direction of the touch position, the positions being away from the one side (for example, see FIG. 4).

The control unit 10 displays the operation areas OA1 and OA2 at the display positions on the screen 13a set in step S102 (step S103).

Thus, when the control unit 10 detects the first touch operation of sliding the touch position on the screen 13a, the control unit 10 operates as an operation area display control unit for displaying the operation area OA1 (example of a first operation area) on the screen 13a.

The control unit 10 waits for a second touch operation on the screen 13a (step S104). The second touch operation is an operation of sliding the touch position of the first touch operation into the operation area OA1 (example of the first operation area), for example, an operation of dragging an operation icon into the operation area OA1.

When the control unit 10 operating as a detection unit detects the second touch operation (step S104: YES), the control unit 10 moves the map image by sliding (step S105). Furthermore, the control unit 10 displays an operation area OA3 on the opposite side of the starting point SP from the operation area OA1 simultaneously with the start of the sliding of the map image. This allows, for example, the screens illustrated in FIGS. 5 and 6 to be displayed. In the examples of FIGS. 5 and 6, the operation area OA3 is displayed along the left end 13L of the screen 13a.

Thus, when the control unit 10 detects the second touch operation in the operation area OA1 (example of the first operation area), the control unit 10 operates as an object display control unit for moving an object displayed on the screen 13a and that is subject to display control (e.g., map image) by sliding a predetermined distance to the starting point SP side of the touch position of the first touch operation.

Furthermore, the control unit 10 operating as the operation area display control unit displays the operation area OA3 (example of a third operation area) on the opposite side of the starting point SP from the operation area OA1.

The operator can now bring a region of the map image that was previously difficult for a finger to reach closer to the operator side. This enables the operator to easily perform a touch operation on a target location on the map image.

The control unit 10 determines the sliding amount of the map image at a time point when the finger dragging an operation icon is detected to have moved outside the operation area OA1. In other words, even if a second operation (in other words, an operation of dragging an operation icon that has been moved out of the operation area OA1 at least once back into the operation area OA1) is performed, which is the second or subsequent operation in a series of drag operations, the map image does not slide. This prevents the map image from unintentionally sliding.

Furthermore, when the control unit 10 detects a touch operation (example of a fourth touch operation) in the operation area OA3 (example of the third operation area) while the operation area OA3 is being displayed, the control unit 10 returns the display range and scale of the map image (example of a display state of the object) to the state before the second touch operation (in other words, before moving the operation area OA3 a predetermined distance by sliding), eliminates the display of the operation area OA3, and returns the flow to the process of step S101.

Note that if the control unit 10 detects a drop operation of an operation icon rather than the second touch operation (step S104: NO, step S109: YES), the control unit 10 executes a process according to the type and drop position of the dropped operation icon (e.g., process for setting the drop position on the map image as a destination) (step S108).

The control unit 10 waits for a third touch operation on the screen 13a (step S106). The third touch operation is an operation of sliding the touch position of the second touch operation from the operation area OA1 (example of the first operation area) into the operation area OA2 (example of the second operation area), for example, an operation of dragging an operation icon into the operation area OA2.

When the control unit 10 operating as the detection unit detects the third touch operation (step S106: YES), the control unit 10 enlarges the scale of the map image (step S107). This makes it easier for the operator to perform a touch operation for the target location on the map image.

Thus, when the control unit 10 operating as the object display control unit detects a third touch operation on the operation area OA2 (an example of a second operation area), the control unit 10 enlarges the display of the object (e.g., a map image) subject to display control.

The control unit 10 determines the scale of the map image at a time point when the finger dragging an operation icon is detected to have moved outside the operation area OA2. In other words, even if an operation is performed in which an operation icon that has been moved out of the operation area OA2 at least once during a series of drag operations is dragged back into the operation area OA2, the scale of the map image does not change. This prevents the scale of the map image from unintentionally changing.

When the operation icon is dropped on the enlarged map image, the control unit 10 executes a process according to the type and drop position of the dropped operation icon (step S108).

Even if the control unit 10 detects a drop operation of an operation icon (excluding an operation of dropping the operation icon within the operation area OA1) rather than the third touch operation (step S106: NO, step S110: YES), the control unit 10 executes a process according to the type and drop position of the dropped operation icon (step S108).

When a user operation required after dropping the operation icon (such as an operation to select or confirm a predetermined item after dropping, and the like) is completed, the control unit 10 returns the display range and scale of the map image to the state before the second touch operation (in other words, before moving a predetermined distance by sliding), eliminates the display of the operation area OA3, and returns the flow to the process of step S101. Note that if the operation icon is dropped before the second touch operation is performed, the display range and scale of the map image do not change before and after the user operation is completed.

Furthermore, when the operation icon is dropped in the operation area OA1 or OA2, the control unit 10 determines that the drop position is not appropriate and puts the drop operation on hold. The operator can continue the operation by re-dragging the operation icon that has been placed at the inappropriate drop position.

The description provided thus far is a description of exemplary embodiments of the present disclosure. The embodiments of the present disclosure are not limited to those described above, and various modifications are possible within the scope of the technical concept of the present disclosure. For example, appropriate combinations of embodiments and the like that are explicitly indicated by way of example in the specification or obvious embodiments and the like are also included in the embodiments of the present application.

In the abovementioned embodiment, the operation of sliding the touch position on the screen 13a (as a more specific example, a drag operation of the operation icon) has been described as an example of the first touch operation. However, in the present disclosure, the first touch operation is not limited thereto.

For example, an operation of touching an arbitrary position on the screen 13a may be the first touch operation.

In this case, when an arbitrary position on the screen 13a is touched, the operation areas OA1 and OA2 are displayed at positions between the touch position and one side of the screen 13a that is farthest from the touch position from among all sides of the screen 13a, the positions being away from that side.

As a specific example, in the screen display state of FIG. 3, when the operator touches a position slightly to the left of the center of the screen 13a, the two operation areas OA1 and OA2 are displayed slightly to the right of the center of the screen 13a, as in the example of FIG. 4.

In other words, when an operation of touching the screen 13a (example of the first touch operation) is performed, the control unit 10 operating as the operation area display control unit identifies one side (herein, the right end 13R) that is farthest from the touch position of the first touch operation from among all sides of the screen 13a, and displays the operation area OA1 at a position between the identified right end 13R and the touch position of the first touch operation, the position being away from the right end 13R.

Thus, the information processing device according to an embodiment of the present disclosure may be an information processing device connected to a touch-operable display device, and may include: a detection unit for detecting a touch operation on a screen of the display device; an operation area display control unit for displaying a first operation area on the screen when a first touch operation of touching an arbitrary position on the screen is detected by the detection unit; and an object display control unit for, when a second touch operation in the first operation area is detected by the detection unit, moving an object to be displayed on the screen and that is subject to display control by sliding a predetermined distance toward the arbitrary position side touched in the first touch operation. In this case, the operation area display control unit displays the first operation area at a position between the arbitrary position and one side of the screen that is farthest from the arbitrary position from among all sides of the screen, the position being away from the one side.

In the abovementioned embodiment, one map image is displayed on the screen 13a, but in another embodiment, for example, various objects including the map image may be displayed side by side on the screen 13a.

In this case, for example, when an arbitrary position on the screen 13a is touched, the operation areas OA1 and OA2 may be displayed at positions between the touch position and an object displayed on the screen 13a that is the furthest from the touch position from among objects displayed on the screen 13a, the positions being away from the object.

Thus, the information processing device according to an embodiment of the present disclosure may be an information processing device connected to a touch-operable display device, and may include: a detection unit for detecting a touch operation on a screen of the display device; an operation area display control unit for displaying a first operation area on the screen when a first touch operation of touching an arbitrary position on the screen is detected by the detection unit; and an object display control unit for, when a second touch operation in the first operation area is detected by the detection unit, moving an object to be displayed on the screen and that is subject to display control by sliding a predetermined distance toward the arbitrary position side touched in the first touch operation. In this case, the operation area display control unit displays the first operation area at a position between the arbitrary position and an object that is farthest from the arbitrary position from among a plurality of objects including the object subject to display control, the position being away from the object.

Note that objects subject to display control (i.e., objects to be moved a predetermined distance by sliding by the object display control unit) may be all objects displayed on the screen, or may be one or more objects specified by a user operation.

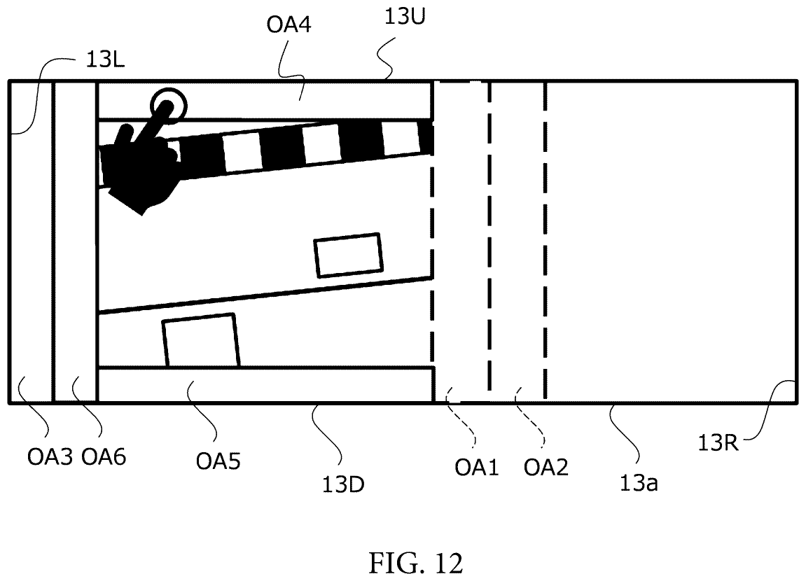

FIG. 12 is a diagram illustrating an example of a screen displayed after the scale of a map image is enlarged in a modified example of the present disclosure.

When the scale of the map image is enlarged, the range of the map displayed on the screen is reduced. Therefore, in the present modified example, an operation area OA4 is displayed along the upper end 13U of the screen 13a. An operation area OA5 is displayed along the lower end 13D of the screen 13a. An operation area OA6 is displayed to the immediate right of the operation area OA3.

When the control unit 10 detects an operation of dragging an operation icon into the operation area OA4, the control unit 10 moves the map image upward by sliding. When the control unit 10 detects an operation of dragging an operation icon into the operation area OA5, the control unit 10 moves the map image downward by sliding. When the control unit 10 detects an operation of dragging an operation icon into the operation area OA6, the control unit 10 moves the map image leftward by sliding. The sliding amount is determined according to, for example, the holding time (time a finger performing the dragging operation remains within each of the operation areas OA4 to OA6).

The operator can check, for example, an area that is no longer visible due to the enlarged scale of the map image by moving the map image by sliding by performing operations on the operation areas OA4 to OA6.

### DESCRIPTION OF REFERENCE NUMERALS

1: In-vehicle system
2: Main unit
10: Control unit
11: Player
12: Sound system
13: Display unit
13a: Screen
14: Operation unit
15. Storage unit
16: GNSS reception unit
17: DR sensor

1. An information processing device, comprising:
a detection unit that detects a touch operation on a screen;
an operation area display control unit that displays a first operation area on the screen when a first touch operation of sliding a touch position on the screen is detected by the detection unit; and
an object display control unit that, when a second touch operation in the first operation area is detected by the detection unit, moves an object to be displayed on the screen and that is subject to display control by sliding a predetermined distance toward a starting point side of the touch position of the first touch operation, wherein
the operation area display control unit displays the first operation area at a position between the starting point and one side of the screen intersecting with a straight line extending in a sliding direction of the first touch operation from the starting point, the position being away from the one side.

2. The information processing device according to claim 1, wherein the detection unit detects an operation of sliding a touch position in the first touch operation into the first operation area as the second touch operation.

3. The information processing device according to claim 1, wherein the operation area display control unit displays the first operation area on the starting point side of a midpoint between the starting point and the one side of the screen.

4. The information processing device according to claim 1, wherein the operation area display control unit displays a second operation area in a position adjacent to the first operation area, and
the object display control unit enlarges a display of the object when the detection unit detects a third touch operation in the second operation area.

5. The information processing device according to claim 4, wherein the detection unit detects an operation of sliding a touch position in the second touch operation from the first operation area to the second operation area as the third touch operation.

6. The information processing device according to claim 1, wherein the operation area display control unit displays a third operation area on an opposite side of the starting point to the first operation area, and
when a fourth touch operation in the third operation area is detected by the detection unit, the object display control unit returns a display state of the object to a display state before the object was moved by the predetermined distance by sliding.

7. The information processing device according to claim 1, which is installed in a vehicle, wherein
a seat row including a first seat and a second seat aligned in a first direction is installed in the vehicle, and
the screen is positioned in front of the seat row and is formed to extend in the first direction.

8. A non-transitory, computer-readable recording medium having stored thereon a computer program that, when executed by an electronic processor of an information processing device, configures the information processing device to execute a process including:
displaying a first operation area on the screen when a first touch operation of sliding a touch position on the screen is detected by the detecting unit; and
when a second touch operation in the first operation area is detected by the detecting unit, moving an object to be displayed on the screen and that is subject to display control by sliding a predetermined distance toward a starting point side of the touch position of the first touch operation,
wherein the first operation area is displayed at a position between the starting point and one side of the screen intersecting with a straight line extending in a sliding direction of the first touch operation from the starting point, the position being away from the one side.
